(19) United States
(12) Patent Application Publication
(10) Pub. No.: US 2023/0148582 A1
(43) Pub. Date: May 18, 2023

(54) Method And System For Controlling And Communicating The Statuses Of Insect Bait Stations

(71) Applicant: SIMTELIGENCE SPRL, Bruxelles (BE)

(72) Inventor: Abraham FROJMOVICS, Bruxelles (BE)

(21) Appl. No.: 17/889,140

(22) Filed: Aug. 16, 2022

Related U.S. Application Data
(63) Continuation of application No. 16/997,676, filed on Aug. 19, 2020, now abandoned.
Application No. 16/997,676 is a continuation of application No. 15/313,485, filed on Nov. 22, 2016, now abandoned.

(30) Foreign Application Priority Data
May 23, 2014 (BE) 2014/0395

(51) Int. Cl. A01M 1/02; A01M 1/10; A01M 1/14; A01M 1/20; G01N 21/59

(52) U.S. Cl. CPC A01M 1/026; A01M 1/023; A01M 1/103; A01M 1/106; A01M 1/14; A01M 1/2011; A01M 1/2016; G01N 21/59

(57) ABSTRACT

A device for controlling at least one insect bait station (100), in particular for insects harmful to humans, animals and plants, in which the bait station is provided with: at least one container (3, 5) provided with an insect entrance opening, the container containing bait and being at least partially transparent or translucent, a lighting device (10) lighting the inside of the container but located outside same, a telecommunication module (23, 25) and a printed circuit comprising, inter alia, a memory and a processor connected to said telecommunication means. The device comprises an optical sensor essentially opposite the lighting device, and connected to the printed circuit (12), which measures the general opacity caused by the insect(s) in the container, the corresponding value being transmitted for processing and analysis of the status of the bait station.

### FIELD OF THE INVENTION

The invention relates to a control and communication device or system and method for bait stations for crawling and flying insects.

It is necessary to regularly inspect the condition of bait stations arranged in different locations inside or outside a building in order to check whether harmful insects have touched them, and to replace the bait stations if necessary. It is also necessary to inspect them to check the number of trapped insects and to compare this number to a benchmark value, to decide whether the number of catches is significant so as to take eradication measures if applicable.

The inspection status and the communication of the results must be provided, in order to be able to take the necessary measures, such as resupplying the bait stations, for example based on pheromones, as well as removing and eliminating the pest.

### BACKGROUND OF THE INVENTION

To that end, it is known in the state of the art to use apparatuses for taking still or moving images that are sent to the server, either over the Internet or using a cellular communication system, such as GSM or GPRS.

The state of the art also teaches the use of systems by which the insects are counted one by one, when they enter a tunnel.

Patent document PCT/US03/09361 describes a system in which counting is done by detecting individual passages by each insect in a field found between a light source and an electronic component that registers the dwindling of the light caused by the passage of the insect.

The methods of the prior art have drawbacks.

A first drawback is the need to send large data files to the server at regular intervals for analysis purposes. These transmissions may, due to their volume, be interrupted due to congestion on the telecommunications lines or may not be sent due to a lack of bandwidth.

A second drawback lies in the fact that data must be sent to the server at regular intervals for verification purposes. This procedure increases the degree of the aforementioned drawback.

A third drawback is the need to empty the traps of the captured insects regularly, so as to be able to photograph a target that is not saturated.

A fourth drawback is the need to renew the bait traps regularly with, for example, pheromones, given that they have a limited efficacy duration.

Counting by passages in front of a light source also has a drawback inasmuch as there is a risk of each insect being counted more than once. The insect may pass several times between the assembly between the light source and the detector, in particular based on its liveliness, and therefore distort the measurement.

### BRIEF DESCRIPTION OF THE INVENTION

One aim of the invention is to propose a method for estimating the number of insects in a detection apparatus itself, instead of communicating unanalyzed data, for example images taken by a photographic device, to the server, so that the latter can perform an analysis.

To that end, the method, system or device according to the invention comprises a bait station preferably provided with an autonomous mobile telephone telecommunications module, which may be made up of a cellular telephone, satellite communication or wireless telecommunications modem, or any other form of telecommunications, as well as an electronic circuit, for example a printed circuit board or an electronic chip, including a memory and processor, inter alia.

The invention is characterized in that the number of insects is estimated by measuring the opacity of a transparent or translucent container, this opacity being caused by the trapped insects, the container being associated on the one hand with a diffuse light source and on the other hand with a sensor or detector, such that the light floods said container.

The intensity of the light detected by the sensor will depend on the type and number of the trapped insects.

The invention therefore proposes to measure the light intensity in a trap container, this intensity varying depending on the number of insects trapped on the translucent wall between this light source and an optical sensor.

To that end, the method, system or device according to the invention comprises a bait station provided with a container that collects the captured insects. According to one simplified embodiment, the latter is characterized by a planar base, made from a translucent material.

Below this translucent base is a light source that is illuminated periodically, according to a pre-established program, which can also be programmed remotely, through an onboard telecommunications system.

The container is at least partially made from a transparent or translucent material, allowing an electronic component measuring the light intensity, such as a photo diode, or any other type of component able to measure the intensity of the light, to perform this measurement.

The intensity of the measured light depends on the opacity produced by the insect captured in the container.

The method according to the invention allows the counting of insects, whose number varies depending on the measurement of the opacity of the container caused by the insects trapped therein. Preferably, there are several containers. Furthermore, each container may contain a specific pheromone that exclusively attracts a specific insect. According to this approach, the capture apparatus is specifically programmed for each type of insect, allowing precise counting relative to the measured opacity.

The invention also proposes to have a battery of the containers, in order to allow the periodic presentation of a container empty of insects, and place the full containers for example at the subsequent disposal of a cleaning service in order to eliminate the contents.

To that end, according to one embodiment, the method, system or device according to the invention is characterized in that a series of containers rests on a disc-shaped platform that rotates by a certain number of degrees around an axis and periodically presents an empty container. The axis of the disc is driven by a motor that rotates so as to present they empty container for examination of its contents.

The motor is preferably managed remotely through the onboard telecommunications system, in order to present the desired container in a timely manner.

The invention therefore also relates to creating a battery of containers in order to allow the use of different attractive products, for example different pheromones, depending on the needs.

According to one embodiment, the pheromone is contained in a known manner in the material, for example plastic, making up the container.

Indeed, according to one aspect of the invention, also proposed is a system for detecting the number of flying or crawling insects, harmful or not for animals, humans, plants, foods or objects, by using a pheromone as bait.

According to one aspect of the invention, the device is provided to analyze the insect content of several containers sequentially.

To that end, a rotating disc is provided supporting several containers. Rotating the disc makes it possible to change the container to be analyzed presented to the detection station.

According to one embodiment, an adhesive strip is used covering the opening of the container, but automatically detaching so that the latter can be exposed to the insects. The use of a detachable adhesive strip improves the efficacy duration of the pheromone or other attractive products found inside the container.

To that end, the method, system or device is characterized in that the rotation of the disc causing the containers to change unsticks said adhesive strip through its gyrating movement, which by default obstructs the device allowing the insects to access the container.

Other equivalent devices or means can be designed to open the container and expose it to the insect in a controlled manner. The means can be a cover tilting during the rotation of the disc under the mechanical effect of a stationary element of the analysis unit.

According to still another aspect of the invention, it is provided that the inner wall of the containers is coated with a lubricating material of the polytetrafluoroethylene type so as to prevent escape attempts by the insects.

Another embodiment uses a set of containers each in the shape of a straight prism able to rotate around an outer axis, for example vertically, provided parallel to an edge of said prisms, and including a light detector (optical diode) in a housing also comprising forward and rear openings able to coincide with the open ends of a single and same one of the containers during the rotational movement.

The side-by-side containers, if one face is convex, can thus form a cylindrical assembly able to rotate around its axis. Periodically, the renewal system for the insect containers, as described in the present invention, imparts a rotating movement to the set of containers.

During the rotating movement, at least one face of the straight prism provided to be transparent or translucent is exposed to one or preferably a set of light-emitting diodes, outside but integrated into a compartment of the housing, illuminating the container and therefore the light detector (sensor). This light source is found in a compartment of the housing whereof the upper face is translucent.

The inner wall of the containers, on the side directly exposed to the emitting diodes, comprises an adhesive substance in order to trap the insects.

The insects enter by the front or rear face in the straight prism. Some insects set down on the glue-covered base and are thus trapped, causing a change during the measurement of the illumination in the container.

Each container or trap can be accessed or replaced individually, in particular when it is necessary to renew the attractive product or exchange the container saturated with insects. They may advantageously assume the form of cartridges made from various materials, for example partially from cardboard, optionally disposable.

The invention also relates to the software that interprets and manages the recorded signals, such as the capture of a pest, a minimum charge indication for the battery, and any other recorded parameter, and sends them to the modem for retransmission to the server.

The invention more particularly relates to the algorithm that establishes the relationship between the measured opacity of the light source caused by the volume of insects and the number of specific insects attracted into the trap during a predetermined period.

To that end, the method, system or device is characterized by the use of a database saved in the memory of the apparatus that contains the names of various insects corresponding to a specific numerical value, related to the opacity of each specific insect when it is subjected to a light source and the residual light is measured on the side opposite this source. This is then a list, a database, or one or several calibration curves associating the number and type of insects with an opacity value for a given exposure time.

To that end, the method, system or device is characterized in that each opacity measurement is saved in the memory of the apparatus and its value is compared to the number of insects relative to an opacity specific to each type of insect.

To that end, the method is characterized in that after each insect measurement, it is compared with a pre-established number of insects defined as being the value corresponding to an infestation. When this value is reached, the apparatus sends an alarm message to the server.

The invention also relates to software that interprets and manages the signals obtained from the server, in order to control the various functions of the trap remotely.

The invention also relates to the communication of the data by satellite transmission.

The invention also relates to the management of the telecommunications, making it possible to send messages through satellite communications and cellular networks, depending on the availability of one or the other transmission method.

To that end, according to still another embodiment of the invention, each time a message is sent to the server, the onboard management system first verifies the availability of the cellular or satellite telecommunications network and sends the message according to the least expensive available communication method. The preferred communication modes are saved in the memory of the apparatus.

In one particular embodiment, the bait station is intended for disease vector insects for human beings as well as animals and is equipped with an insect detection system for managing and transmitting data related thereto, according to the invention.

According to one particular embodiment, the bait station is also intended to diffuse a product to combat or eradicate the insect.

To that end, the method, system or device is characterized in that a product to combat or eradicate the insect is diffused remotely, when a degree of infestation is recorded.

### BRIEF DESCRIPTION OF THE FIGURES

These aspects, as well as other aspects of the invention, will be further explained in the following description of specific embodiments of the invention, reference being made to the appended schematic figures, in which:

FIG. 1 is a general diagram illustrating a device according to the invention.

FIG. 2 schematically shows the introduction of a flying insect into a trap. Attracted by the pheromone located in the container 5, it enters through the opening 1 and continues along its way, still attracted by the pheromone, through the funnel, which naturally guides it toward the junction between the funnel and the chimney 4, which is secured to the container.

Once the insect enters the container 5, it is trapped, given that it no longer has any support to take flight.

Naturally, the insect tries to climb the walls of the container. These are covered with a slippery material such as polytetrafluoroethylene, which makes these attempts difficult, or even prevents them completely.

FIG. 3 schematically shows the part of the system that sees to controlling the number of insects trapped, by measuring the opacity created by the number of insects in the container 5.

FIG. 4 diagrammatically shows the rotation system for the tray of the containers that periodically cause the discharge of checked insects and the renewal or change of the type of pheromone.

FIG. 5 schematically shows a perspective view of the automatic opening system for access to the containers, allowing the fragrance of the pheromone to escape, via an adhesive strip that detaches partially and automatically upon each rotational movement of the tray of the containers.

FIG. 6 shows the motor that drives the gyrating movement of the tray of the containers, the onboard electronic management device, which manages the device as well as the telecommunications with the server, through a satellite communication system.

FIG. 7 shows an alternative, as used for crawling insects.

FIG. 8 shows an alternative, as used for insects that are disease vectors for humans and animals.

FIG. 9 schematically shows the automatic diffusion system for a product to combat or eradicate insects.

FIG. 10 schematically illustrates, in sectional view seen from the front, another embodiment of a device according to the invention.

FIG. 11 schematically illustrates a sectional view of the device of FIG. 10 seen from the side.

### DETAILED DESCRIPTION OF PARTICULAR EMBODIMENTS OF THE INVENTION

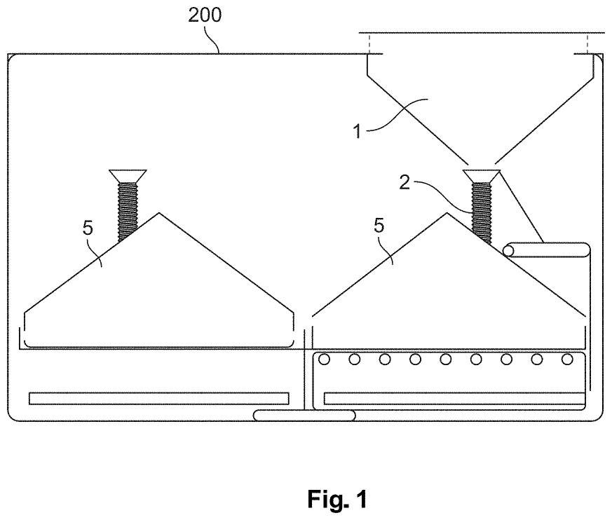

FIG. 1 shows a diagram of the entire bait station (housing 200), which includes the funnel 1, which accommodates the insects to be captured, the chimney 2, which is the lock preventing the captured insects from leaving. The upside down cone 5 is the container where the captured insects are counted. This upside down cone rests on a gyrating disc that allows the cones to change position at specific moments in order to eliminate the captured insects automatically and that also automatically adjusts any change in pheromone.

Below the gyrating disc is a compartment that comprises a series of LED-type bulbs as well as a printed circuit that manages the trap, and all mechanical and electronic functions. It also includes one or several modems, performing the telecommunications functions.

These modems can be of the cellular telephone, GSM, satellite and radio frequency type with free usage, such as ISM, or the licensed type, such as Bluetooth, Wi-Fi, and any other type of wireless telecommunications.

The drawing shows an embodiment with four containers found in the gyrating tray. This number can vary and may therefore be higher.

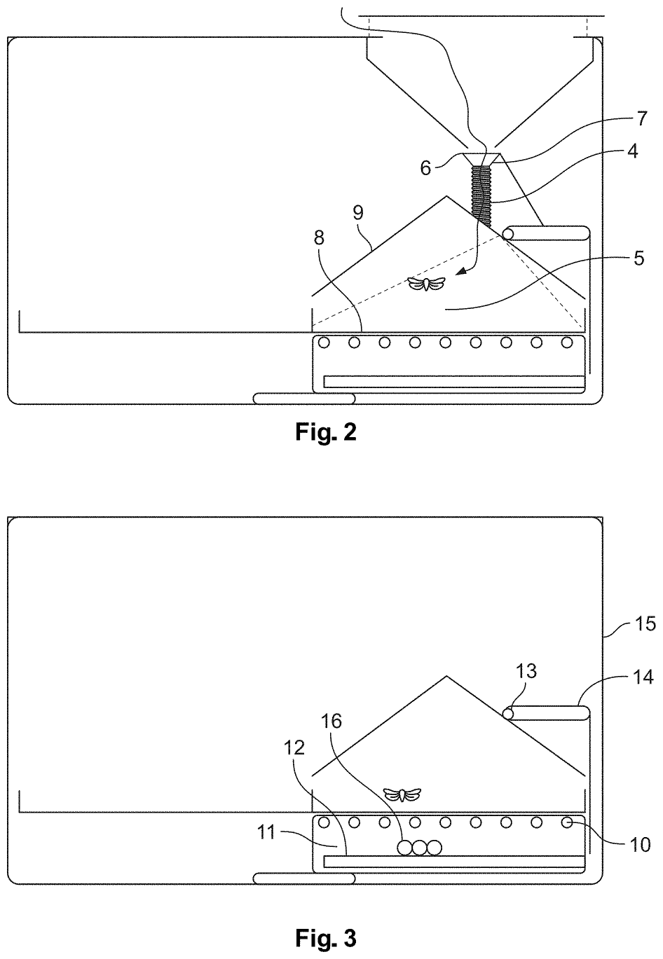

FIG. 2 schematically shows the journey of the insect entering the trap. Attracted by the fragrance given off by the pheromone found in the container 5, it enters through the opening 6, which is at the top of the funnel 7 at the top of the chimney 4.

It subsequently enters the chimney 4 through the entrance 6 to reach the container 5. It either sets down on the base of the container 5, or continues to fly therein as long as it remains alive and has energy. In both cases, it finishes its journey on the base 8, since it has no other choice. In some cases, it will try to climb the wall 9. This wall may be covered, made up of or manufactured from a layer of slippery material, such as polytetrafluoroethylene.

FIG. 3 illustrates the operation of the system on which the periodic counting of the trapped insects is based.

Periodically, LED-type bulbs 10 or other bulbs, preferably of the type with low energy consumption simultaneously able to produce a high brightness, light up according to an onboard program, found in the same housing 11 as the printed circuit board 12.

The bulbs are programmed to light up only during dark hours at night, so as not to interfere with the daytime light, which may enter through the opening 6.

The upper wall of the housing 5 is made from a translucent material, which allows the light emitted by the LED bulbs 10 to pass.

The onboard management program on the printed circuit board 12 simultaneously triggers the optical sensor 13, which is found on the arm 14.

The conical wall of the container 9 is transparent, which allows the light from the LED bulb to light the inside of the container perfectly.

As the number of insects in the container increases, the brightness of the light recorded by the optical sensor 13 is reduced more and more.

Each specific insect has an imprint defined by the mass of its body and thus produces an opacity between the light source 10 and the optical sensor 13.

The printed circuit board 12 is provided with a memory medium, on which a database is saved, which comprises a list of a series of insects.

This list can be managed remotely by an application found on a server located remotely or may be on board in the application of the apparatus.

Each insect included on the list has a value expressing the corresponding opacity.

As insects are captured, the periodic opacity measurement indicates an increasing value relative to the number of insects.

When the value of the measured opacity and, consequently, the number of insects reaches a certain pre-established ceiling, which is stored in the memory of the printed circuit board, an alarm signal is triggered. This signal is next sent to the server, which in turn sends it to the user, still through telecommunications.

The telecommunications between the PCB and the server are done by satellite communications, which may for example be the TDMA technique.

The wall 15 of the assembly of the apparatus is made from a synthetic material that is robust, so as to be able to withstand bad weather. It is also completely opaque, so as to provide complete sealing against outside light, so that there is no interference with the intensity measurement of the light produced by the bulbs 10.

The energy necessary to see to the operation of the printed circuit board is provided by the batteries or the series of electric power cells 16 found inside the housing 11.

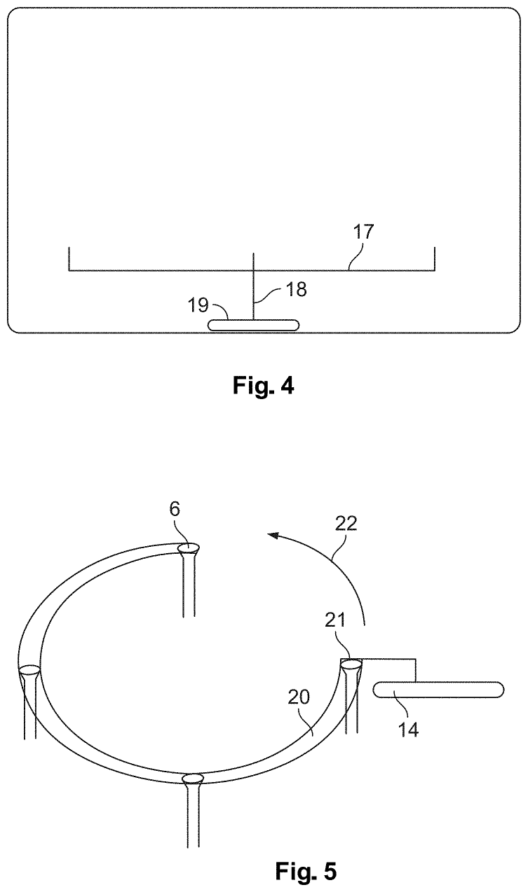

FIG. 4 illustrates the operation of the system for rotating the tray 17 on which the containers 5 are fixed in which the insects are trapped.

The tray is circular and made from a synthetic material that is at least partially transparent. Transparency is necessary to ensure passage of the light coming from the bulbs 10 that must be measured by the optical sensor 13.

The tray is provided at its center with an axis 18, around which the tray 17 pivots. An electric motor 19 drives the axis in a gyrating movement. This motor is provided with energy delivered by the battery or the series of fuel cells 16.

The motor periodically imparts a gyrating movement. The frequency and the angle of the gyrating movement are managed by the onboard program on the printed circuit board 12.

This program is also managed remotely through telecommunications. The user can change the frequency parameters, as well as the angle of the gyrating movement, locally and remotely.

The angle of advance of the gyrating movement makes it possible to precisely place a specific container such that the access chimney to the container 4 is found across from the outlet of the upper access funnel 1. This operation serves to eliminate the series of insects that have already been counted and to provide the system with a new empty container for a new counting of insects.

The angle of advance of the gyrating movement also makes it possible to place a specific container 5 provided with the specific pheromone to attract a specific insect.

The pheromone is found in the container either in a pellet, receptacle or any other support provided with qualities for dispersing the fragrance of the pheromone, but may also be incorporated into the inner wall of the container 9 for dispersion of the fragrance.

FIG. 5 illustrates the operation of the system for opening the orifice of each container in order to allow the pheromone contained therein to spread outside the container.

The motor 19 drives the gyrating movement of the tray 17 that is managed by the program on the printed circuit board 12.

All of the chimneys of the containers are covered by a partially circular strip 20 of flexible material, of the paper or synthetic material type. This is coated underneath with an adhesive product that has the ability to hermetically seal the upper orifice 6 of each chimney 4.

A clamp element 21 that is fixed to the arm 14 pinches one end of the circular adhesive strip 20.

During a programmed movement of the motor 19, this gyrating movement as indicated by arrow 22 unsticks the partially circular adhesive strip and consequently frees the upper orifice of the chimney 6, and then allows the diffusion of the pheromone captured in the container 5 toward the outside of the apparatus.

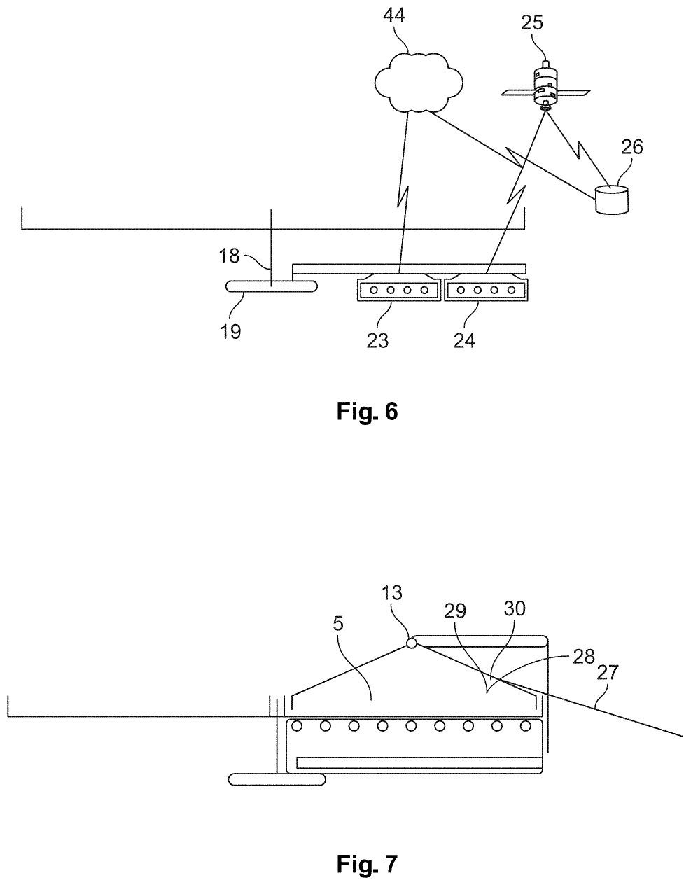

FIG. 6 shows the motor 19 that imparts the rotation of the axis 18 is connected to the printed circuit board 12, which ensures the management thereof through an onboard program. The remote communication is provided by satellite modem 23, as well as a cellular modem 24. The choice of a telecommunications mode depends on the local GSM coverage 44. If it is absent, the onboard management program chooses the telecommunications mode by satellite channels, for example of the TDMA type 25, so as to be able to communicate with a server 26 via a satellite that sees to the management of the system as a whole. The system as a whole is a set of managed bait stations.

FIG. 7 shows an alternative bait station intended to trap crawling insects. To that end, a ramp 27 allows access to the insects attracted inside the container 5, using the pheromone released in the latter. The end of the ramp 28 ends with a flexible tongue 29, coated with or made up of a material such as polytetrafluoroethylene, which causes the insects to fall inside the container 5 by gravitational force.

This flexible tongue makes it possible, due to its tongue shape but nevertheless having a certain rigidity, to be inserted into the orifice 30, after each gyrating movement of the tray.

This alternative is also provided with a circular adhesive strip 20 as well as a clip 21 that releases the pheromone, after each partial rotation of the circular tray 17.

In this alternative, the optical sensor 13 is located above the upside down cone of the transparent container.

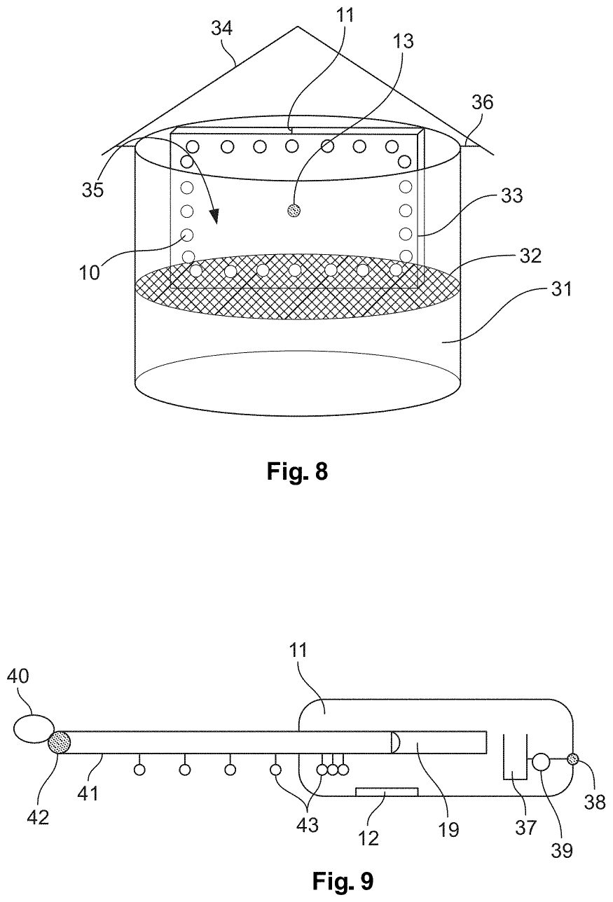

FIG. 8 shows an alternative of the bait station intended more particularly to trap insects of the mosquito (Culicidae) type such as Aedes aegypti, Aedes albopictus, Anopheles, Culex, Phlebotominae and types of flies such as Musca domestica, Tsetse fly, Simulium damnosum, & bedbugs.

This bait station is characterized by a container whereof the lower part 31 is filled with a liquid that is characterized by its attractiveness for a certain type of insect. The level of this liquid is covered by a grating face 32. The inner part of the container is partially provided with a translucent wall 33 that is coated with a transparent adhesive material.

The insects to be trapped are attracted by the attractive liquid and glued to the adhesive wall 33, and enter the cylindrical traps through the circular orifice 36, along the direction indicated by arrow 35. The bait station is covered by a cone 34 serving to isolate the inside of the trap from stray light coming from outside the latter so as not to distort the intensity of the light source used for optical counting purposes of the trapped insects. The inside of the trap is also black, so as to limit this stray light.

Periodically, the LED bulbs 10 light up at the same time as the optical sensor 13 is triggered, and the opacity of the trapped insects in the adhesive substance 33 is measured.

The optical sensor 13 is fixed on the inner wall of the cylindrical container, opposite the translucent wall 33.

The bulbs 10, the fuel cells or batteries 16, as well as the printed circuit board 12 are found in a housing 11, similar to the other alternatives of the invention.

The management of the kind of the insects and the telecommunications of the data are provided by the onboard program found on the printed circuit board, using the same system, method and process according to the invention.

FIG. 9 shows a system for diffusing a product for combating or eradicating insects. This bait station is characterized by a container 37 that contains the treatment product and is diffused by an orifice 38 using a pump 39 operating using the motor 19.

The latter is managed by the onboard program, which is found on the printed circuit board 12. This program is directed remotely by the instructions from the server 26.

In one alternative, the program can be managed based on data generated locally on the printed board, depending on the degree of insect infestation.

In one alternative, the product for combating or eradicating insects is contained in a series of cannulas 43. The latter are deployed in the field for treatment using an endless cable 41 on which the cannulas 43 containing the product for combating or eradicating insects are attached.

The cannulas 43 are attached at a regular distance on an endless rope, one end of which is provided with a pulley 42 attached to any stationary object 40, found at a certain distance.

Depending on the specific command coming from the onboard program found on the printed circuit board 12, the motor 19 drives the cable 41, which releases the cannulas that are distributed along the cable on the terrain to be treated.

The product is released when the cannulas leave the cavity 11.

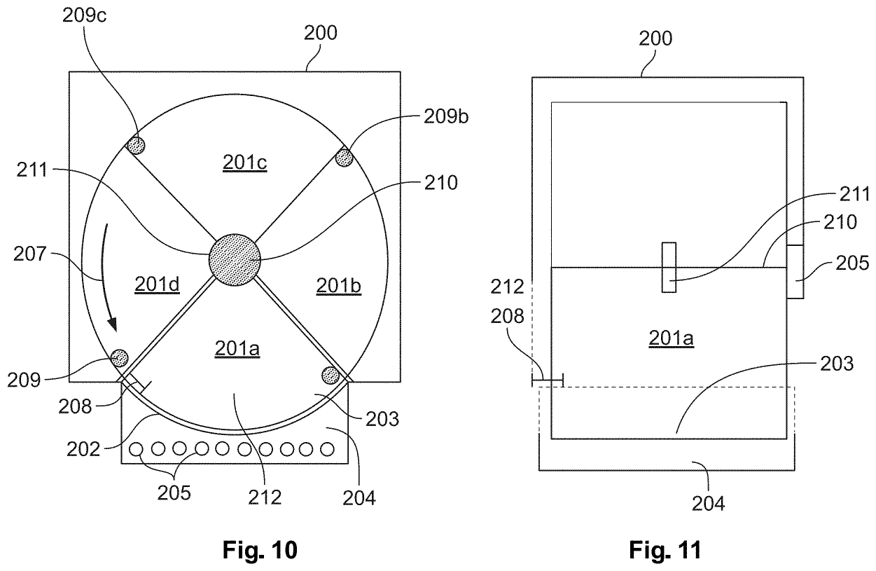

FIGS. 10 and 11 illustrate a second embodiment of a device according to the invention in the form of a sectional view of the front and side of a housing 200 including four containers 201 (201-a, b, c, d) for insects to be trapped.

The containers are in the form of a straight prism, one wall 202 of which is translucent and convex and is coated on its inner face with an adhesive product 203. These four containers 201 are arranged to form a horizontal cylinder contained in the housing 200 and able to be set in rotation by a motor 205. The containers are open in the front and rear, making it possible, for one facing an approximately triangular opening 212 of the housing, to receive the insects attracted by an attractive product.

The containers are able to rotate by a quarter circle when a periodic corresponding command is emitted by the system, in order to present the next container across from the forward and rear openings of the housing 200. The translucent and adhesive convex wall of this container faces the stationary compartment 204 comprising diodes 205 with a translucent upper face, and emitting the diffuse light in the container 201 that is exposed thereto.

An optical sensor 211 (photodiode) is provided at the rotation axis 210 in order to measure the light intensity in the container thus exposed.

It will be noted that in this alternative, the renewal of the attractive product that is no longer effective is done through the rotational movement by a quarter revolution (arrow 207) imparted to the set of containers 201. During this rotation, a cutting tongue 208 pierces a small container 209 where the attractive product is located and that is associated with each container 201. The attractive product (for example, fragrance) is thus released in the container in communication with the outside through the openings of the housing.

What is claimed is:

1.-12. (canceled)

13. A device for checking at least one bait station for insects, especially pests for humans, animals and plants, wherein the at least one bait station comprises:
at least one container comprising at least one entrance orifice for insects, wherein the at least one container contains bait and wherein the at least one container is at least partially transparent or translucent;
a lighting device disposed toward the inside of, but on the outside of, the at least one container;
a printed circuit board, comprising a memory;
an optical sensor disposed generally opposite the lighting device, and connected to the printed circuit board, that measures the opacity caused by an insect trapped in the at least one container and that measures the opacity caused by several insects trapped in the container, the corresponding value being sent for checking and control of the status of the bait station.

14. The device according to claim 13, further comprising a telecommunications means, the printed circuit board further including a processor connected to said telecommunications means.

15. The device according to claim 14, wherein the sending of the value is carried out by the telecommunications means to a checking and/or control station, eventually in the form of an internet server, to conduct an evaluation of the presence and/or number of insects trapped in said at least one container.

16. The device according to claim 13, wherein the at least one container includes multiple containers, and wherein the multiple containers are included in a housing.

17. The device according to claim 16, further comprising means configured to successively and automatically present the containers, by a platform, between the optical sensor and the lighting device.

18. The device according to claim 17, wherein the containers are disposed around an axis able to be driven by a motor controlled by the printed circuit board in accordance with a program.

19. The device according to claim 13, wherein at least part of an inner wall of the at least one container is covered with a sticky or adhesive substance able to trap the insects.

20. The device according to claim 13, wherein the at least one container contains a pheromone integrated into material making up the at least one container.

21. The device according to claim 20, wherein the at least one container includes multiple containers and wherein each of the multiple containers contains a specific pheromone.

22. The device according to claim 14, wherein the telecommunications means is an autonomous mobile telephone module comprising one or more of a cellular telephone module, a satellite communication module, and/or a wireless telecommunication module.

23. The device according to claim 13, further comprising a lateral ramp configured to allow the insects to enter the bait station via the lateral ramp before falling into the at least one container.

24. A method comprising checking at least one bait station for insects, especially pests for humans, animals and plants, wherein the at least one bait station includes:
at least one container comprising at least one entrance orifice for the insects, wherein the at least one container contains bait and wherein the at least one container is at least partially transparent or translucent;
a lighting device disposed toward the inside of, but on the outside of, the at least one container;
a printed circuit board, comprising a memory;
an optical sensor disposed generally opposite the lighting device, and connected to the printed circuit board, that measures the opacity caused by an insect trapped in the at least one container and that measures the opacity caused by several insects trapped in the container, the corresponding value being sent for checking and control of the status of the bait station.
